(19) United States
(12) Patent Application Publication
(10) Pub. No.: US 2023/0207790 A1
(43) Pub. Date: Jun. 29, 2023

(54) LITHIUM SECONDARY BATTERY

(71) Applicant: TeraWatt Technology K.K., Yokohama-shi (JP)

(72) Inventors: Masatsugu Nakano, Yokohama-shi (JP); Ken Ogata, Yokohama-shi (JP); Hiroshi Imoto, Yokohama-shi (JP)

(73) Assignee: TeraWatt Technology K.K., Yokohama-shi (JP)

(21) Appl. No.: 18/111,334

(22) Filed: Feb. 17, 2023

Related U.S. Application Data
(63) Continuation of application No. PCT/JP2020/031096, filed on Aug. 18, 2020.

(51) Int. Cl. H01M 4/38; H01M 50/46

(52) U.S. Cl. CPC H01M 4/382; H01M 50/46; H01M 2004/027

(57) ABSTRACT

The purpose of the present invention is to provide a lithium secondary battery having a high energy density and an excellent cycle characteristic. The present invention relates to a lithium secondary battery having a positive electrode, a negative electrode not having a negative-electrode active material, a separator or a solid electrolyte placed between the positive electrode and the negative electrode, and at least one selected from the group consisting of a metal layer formed on the surface of the negative electrode facing the separator or the solid electrolyte and a fibrous or porous buffering function layer formed on the surface of the separator or the solid electrolyte facing the negative electrode, the buffering function layer having ionic conductivity and electronic conductivity, wherein the positive electrode contains a positive-electrode active material and a lithium-containing compound causing an oxidation reaction and not substantially causing a reduction reaction in a charge/discharge potential range of the positive-electrode active material.

### BACKGROUND

### Field

The present invention relates to a lithium secondary battery.

### Description of Related Art

The technology of converting natural energy such as solar light and window power into electric energy has recently attracted attentions. Under such a situation, various secondary batteries have been developed as a highly-safe power storage device capable of storing a lot of electric energy.

Among them, secondary batteries which perform charge/discharge by transferring metal ions between a positive electrode and a negative electrode are known to exhibit a high voltage and a high energy density. Typically, lithium-ion secondary batteries are known. Examples of the typical lithium-ion secondary batteries include those which have a positive electrode and a negative electrode having, introduced thereon, an active material capable of retaining lithium and perform charge/discharge by delivering or receiving lithium ions between a positive-electrode active material and a negative-electrode active material. In addition, as a secondary battery having a negative electrode for which no active material is used, there has been developed a lithium-metal secondary battery which precipitates a lithium metal on the surface of a negative electrode and thereby retaining lithium thereon.

For example, Patent Document 1 discloses a high-energy-density and high-output lithium-metal anode secondary battery having a volume energy density exceeding 1000 Wh/L and/or a mass energy density exceeding 350 Wh/kg at the time of discharge at at least a rate of 10 at room temperature. Patent Document 1 discloses the use of an ultrathin lithium-metal anode for manufacturing such a lithium-metal anode secondary battery.

Patent Document 2 discloses a lithium secondary battery including a positive electrode and a negative electrode, and a separation membrane and an electrolyte interposed therebetween. In the aforesaid negative electrode, metal particles are formed on a negative electrode current collector and transferred from the positive electrode, when the battery is charged, to form lithium metal on the negative electrode current collector in the negative electrode. Patent Document 2 discloses that such a lithium secondary battery shows the possibility of providing a lithium secondary battery which has overcome the problem due to the reactivity of the lithium metal and the problem caused during assembly and therefore has improved performance and service life.

### PATENT DOCUMENTS

Patent Document 1: Published Japanese Translation of PCT application No 2019-517722
Patent Document 2: Published Japanese Translation of PCT application No 2019-537226

### SUMMARY

As a result of detailed investigation of conventional batteries including those described in the above patent documents, the present inventors have found that at least either one of their energy density and cycle characteristic is not sufficient.

For example, a typical secondary battery which carries out charge/discharge by delivering or receiving metal ions between a positive-electrode active material and a negative-electrode active material does not have a sufficient energy density. A conventional lithium-metal secondary battery which precipitates a lithium metal on the surface of a negative electrode and thereby retains lithium thereon, as described in the aforesaid patent document, is likely to form a dendrite-like lithium metal on the surface of the negative electrode after repetition of charge/discharge and cause a short circuit and capacity reduction. This results in an insufficient cycle characteristic.

In a lithium-metal secondary battery, a method of applying a large physical pressure on a battery to keep the interface between a negative electrode and a separator at high pressure has also been developed in order to suppress the discrete growth at the time of lithium metal precipitation. Application of such a high pressure however needs a large mechanical mechanism, leading to an increase in the weight and volume of the battery and a reduction in energy density as the entire battery.

The present invention has been made in consideration of the aforesaid problems and a purpose is to provide a lithium secondary battery having a high energy density and excellent in cycle characteristic.

The lithium secondary battery according to one embodiment of the present invention has a positive electrode, a negative electrode not having a negative-electrode active material, a separator placed between the positive electrode and the negative electrode, and at least one selected from the group consisting of a metal layer formed on the surface of the negative electrode facing the separator and a fibrous or porous buffering function layer having ionic conductivity and electronic conductivity and formed on the surface of the separator facing the negative electrode. The positive electrode contains a positive-electrode active material and a lithium-containing compound causing an oxidation reaction and causing substantially no reduction reaction in a charge/discharge potential range of the positive-electrode active material (the lithium-containing compound will hereinafter also be called “positive-electrode sacrificial agent”).

Such a lithium secondary battery equipped with a negative electrode not having a negative-electrode active material has a high energy density because a lithium metal precipitates on the surface of the negative electrode and charge/discharge are performed by depositing lithium metal on the surface of the negative electrode and electrolytically dissolving the deposited lithium. In addition, the lithium secondary battery according to the one embodiment of the present invention is equipped with at least one of the metal layer and the buffering function layer. When the lithium secondary battery has the metal layer on the surface of a negative electrode, the electronic conductivity of the metal layer makes the electric field occurring on the surface of the negative electrode more uniform and facilitates the uniform precipitation of a lithium metal on the surface of the negative electrode (this means that the growth of the lithium metal into dendrite form on the negative electrode is suppressed). The lithium secondary battery having the buffering function layer on the surface of the separator enables the precipitation of a lithium metal not only on the surface of the negative electrode but also in the fibrous or porous buffering function layer having ionic conductivity and electronic conductivity, so that the surface area of a reaction site of a lithium metal precipitation reaction increases and the rate of the lithium metal precipitation reaction is controlled slowly. As a result, the growth of a lithium metal into dendrite form on the negative electrode is suppressed.

Further, the lithium secondary battery according to the one embodiment of the present invention has not only a metal layer or a buffering function layer but also the positive-electrode sacrificial agent as described above on the positive electrode. The positive-electrode sacrificial agent as described above causes an oxidation reaction at the initial charge time of the lithium secondary battery (this means emission of a lithium ion) but does not substantially cause a reduction reaction at the time of discharge (this means that a lithium-containing compound before discharge is not formed) and the lithium element derived from the lithium-containing compound remains as a lithium metal on the surface of the negative electrode or on the surface of the buffering function layer. In the lithium secondary battery having such a positive-electrode sacrificial agent, not all of the lithium metal precipitated on the surface of the negative electrode or on the surface of the buffering function layer dissolves, and even after completion of the discharge, some of the lithium metal remains on the surface of the negative electrode or on the surface of the buffering function layer. In the lithium secondary battery according to the one embodiment of the present invention having the metal layer or buffering function layer in addition to the positive-electrode sacrificial agent, it is presumed that some of the lithium metal remains on the negative electrode even after completion of the discharge and the residual lithium metal remains uniformly on the surface of the negative electrode or on the surface of the buffering function layer. As a result, the residual lithium metal becomes a scaffold for the precipitation of a new lithium metal on the surface of the negative electrode or on the surface of the buffering function layer at the time of subsequent charge and therefore, a lithium metal is likely to precipitate more uniformly on the surface of the negative electrode or on the surface of the buffering function layer at the time of the charge. Since the growth of a lithium metal into dendrite form on the negative electrode is suppressed, the aforesaid lithium secondary battery is able to have an excellent cycle characteristic.

The aforesaid separator may be replaced by a solid electrolyte. According to such a mode, a lithium secondary battery can be obtained as a solid battery and therefore, the resulting lithium secondary battery has higher safety.

The lithium secondary battery according to the one embodiment of the present invention preferably includes both the metal layer and the buffering function layer. In such a mode, the aforesaid metal layer and buffering function layer display their effects respectively, so that the growth of a lithium metal into dendrite form on the surface of the negative electrode is suppressed further and the lithium secondary battery thus obtained has a more excellent cycle characteristic.

The proportion of the irreversible capacity of the aforesaid lithium-containing compound in the cell capacity of the lithium secondary battery is preferably 1% or more and 30% or less. In such a mode, the amount of the lithium which is to remain on the surface of the negative electrode or on the surface of the buffering function layer at the time of discharge becomes more appropriate, so that the resulting lithium secondary battery has more improved cycle characteristic and energy density.

The porosity of the buffering function layer is preferably 50% or more. In such a mode, the aforesaid buffering function layer displays its effect more effectively and reliably, so that the resulting lithium secondary battery has more improved cycle characteristic and energy density.

The buffering function layer may include a fibrous or porous ionically conductive layer and an electronically conductive layer which covers the ionically conductive layer.

The average thickness of the metal layer is preferably 5 nm or more and 5000 nm or less. In such a mode, the electric field occurring on the surface of the negative electrode becomes more uniform, so that the growth of a lithium metal into dendrite form on the negative electrode is suppressed further.

The metal layer contains at least one selected from the group consisting of Si, Sn, Zn, Bi, Ag, In, Pb, Sb, and Al. In such a mode, the resulting metal layer has more improved affinity with lithium, so that peeling-off of the lithium metal precipitated on the negative electrode is suppressed further.

The aforesaid lithium secondary battery is a lithium secondary battery in which charging and discharging are performed by depositing lithium metal on the surface of the negative electrode and dissolving the deposited lithium. In such an embodiment, the lithium secondary battery has a higher energy density.

The negative electrode preferably consists of at least one selected from the group consisting of Cu, Ni, Ti, Fe, and other metals that do not react with Li, alloys thereof, and stainless steels (SUS). In such a mode, use of a lithium metal having high flammability is not required for the production, so that a negative electrode having more excellent safety and productivity can be obtained. In addition, such a negative electrode is stable and therefore, a secondary battery obtained using it has an improved cyclic characteristic.

The aforesaid lithium secondary battery preferably has no lithium foil on the surface of the aforesaid negative electrode before initial charge. In such a mode, it has more excellent safety and excellent productivity because it does not need a lithium metal having high flammability for the production.

The aforesaid lithium secondary battery has preferably an energy density of 350 Wh/kg or more.

The present invention makes it possible to provide a lithium secondary battery having a high energy density and an excellent cycle characteristic.

### BRIEF DESCRIPTION OF DRAWINGS

FIG. 1 is a schematic cross-sectional view of a lithium secondary battery according to First Embodiment.

FIG. 2 is a schematic cross-sectional view of the use of the lithium secondary battery according to First Embodiment.

FIG. 3 is a schematic cross-sectional view of a lithium secondary battery according to Second Embodiment

FIG. 4 is a schematic cross-sectional view of a buffering function layer in the lithium secondary battery according to Second Embodiment, in which (A) shows a fibrous buffering function layer which is one embodiment of the buffering function layer, (B) shows a precipitation mode of a lithium metal on the fibrous buffering function layer, and (C) shows one embodiment of a member constituting the fibrous buffering function layer.

FIG. 5 is a schematic cross-sectional view of a lithium secondary battery according to Third Embodiment.

FIG. 6 is a schematic cross-sectional view of a lithium secondary battery according to Fourth Embodiment.

### DETAILED DESCRIPTION

The embodiment of the present invention (which will hereinafter be called “present embodiment”) will hereinafter be described in detail while referring to the drawings as needed. In the drawings, the same element will be represented by the same reference numeral and an overlapping description will be omitted. Unless otherwise specifically described, the positional relationship such as vertical or horizontal one will be based on the positional relationship shown in the drawings. Further, a dimensional ratio in the drawings is not limited to the ratio shown in the drawings.

### First Embodiment

(Lithium Second Battery)

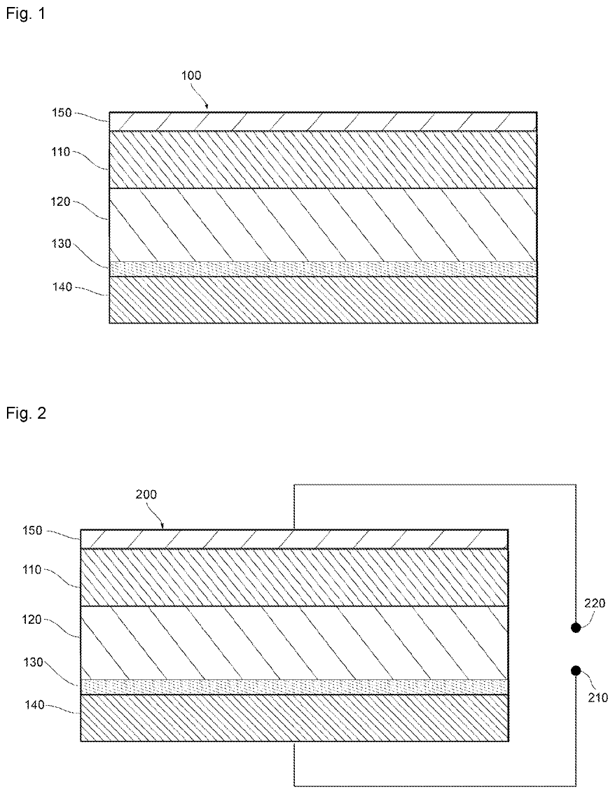

FIG. 1 is a schematic cross-sectional view of a lithium secondary battery of First Embodiment. As shown in FIG. 1, a lithium secondary battery 100 of First Embodiment includes a positive electrode 110, a negative electrode 140 not having a negative-electrode active material, a separator 120 placed between the positive electrode 110 and the negative electrode 140, and a metal layer 130 formed on the surface of the negative electrode 140 facing the separator 120. The positive electrode 110 has a positive electrode current collector 150 on the surface thereof opposite to the surface facing the separator 120.

(Negative Electrode)

The negative electrode 140 does not have a negative-electrode active material. A lithium secondary battery including a negative electrode having a negative-electrode active material is hard to have an enhanced energy density due to the presence of the negative-electrode active material. On the other hand, the lithium secondary battery 100 of the present embodiment includes the negative electrode 140 not having a negative-electrode active material, so that it has no such a problem. In other words, the lithium secondary battery 100 of the present embodiment has a high energy density because charging and discharging are performed by depositing lithium metal on the surface of the negative electrode 140 and electrolytically dissolving the deposited lithium.

In the present embodiment, the term “a lithium metal precipitates on the surface of the negative electrode” means that a lithium metal precipitates on at least one of the surface of the negative electrode, the surface of the metal layer formed on the surface of the negative electrode, and the surface of a solid electrolyte interface (SEI) layer, which will be described later, formed on the surface of the negative electrode and/or metal layer. In the lithium secondary battery of the present embodiment, the lithium metal is presumed to mainly precipitate on the surface of the metal layer or the surface of the SEI layer formed on the surface of the metal layer, but the position on which the lithium metal precipitates is not limited to the aforesaid ones. In the lithium secondary battery 100, therefore, the lithium metal may precipitate, for example, on the surface of the negative electrode 140 (the interface between the negative electrode 140 and the metal layer 130) or on the surface of the metal layer 130 (interface between the metal layer 130 and the separator 120).

The term “negative-electrode active material” as used herein means a material for retaining, on the negative electrode 140, a lithium ion or a lithium metal (which will hereinafter be called “carrier metal”) which will serve as a charge carrier in a battery and it may be replaced by the term “host material of a carrier metal”. Such a retaining mechanism is not particularly limited and examples of it include intercalation, alloying, and occlusion of metal clusters.

Such a negative-electrode active material is not particularly limited and examples include carbon-based materials, metal oxides, and metals or alloys. The carbon-based material is not particularly limited and examples include graphene, graphite, hard carbon, mesoporous carbon, carbon nanotube, and carbon nanohorn. The metal oxide is not particularly limited and examples include titanium oxide-based compounds, tin oxide-based compounds, and cobalt oxide-based compounds. The metals or alloys are not particularly limited insofar as they can be alloyed with the carrier metal and examples include silicon, germanium, tin, lead, aluminum, and gallium and alloys containing them.

The negative electrode 140 is not particularly limited insofar as it does not have a negative-electrode active material and is usable as a current collector. Examples include electrodes consisting of at least one selected from the group consisting of Cu, Ni, Ti, Fe, and other metals that do not react with Li, alloys thereof, and stainless steels (SUS). When a SUS is used as the negative electrode 140, a variety of conventionally known SUSs can be used as its kind. One or more of the negative electrode materials may be used either singly or in combination. The term “metal that does not react with Li” as used herein means a metal which does not form an alloy under the operation conditions of the lithium secondary battery, reacting with a lithium ion or a lithium metal.

The negative electrode 140 is preferably an electrode containing no lithium. In such an embodiment, it can be manufactured without using a highly flammable lithium metal, so that the resulting lithium secondary battery 100 has higher safety and more excellent productivity. From a similar standpoint and the standpoint of obtaining a negative electrode 140 having improved stability, the negative electrode 140 more preferably consists of at least one selected from the group consisting of Cu and Ni, and an alloy thereof, and a stainless steel (SUS). From a similar standpoint, the negative electrode 140 still more preferably consists of Cu or Ni, or an alloy thereof and particularly preferably consists of Cu or Ni.

The term “negative electrode does not have a negative-electrode active material” as used herein means that the content of the negative-electrode active material in the negative electrode is 10 mass % or less based on the total amount of the negative electrode. The content of the negative-electrode active material in the negative electrode is preferably 5.0 mass % or less and it may be 1.0 mass % or less, 0.1 mass % or less, or 0.0 mass % or less, each based on the total amount of the negative electrode. The term “the lithium secondary battery 100 includes a negative electrode not having a negative-electrode active material” means that the lithium secondary battery 100 is, in a commonly used sense, an anode-free secondary battery, zero-anode secondary battery, or anode-less secondary battery.

In a typical lithium-ion secondary battery, the capacity of the negative-electrode active material in the negative electrode is set to be equal to that of the positive electrode. In the lithium secondary battery 100, on the other hand, the negative electrode 140 has the metal layer 130 on the surface thereof and the metal layer may contain a metal reactive with lithium but the capacity of the metal is sufficiently smaller than that of the positive electrode, so that the lithium secondary battery 100 can be said to “include a negative electrode not having a negative-electrode active material”.

The total capacity of the negative electrode 140 and the metal layer 130 is sufficiently small relative to the capacity of the positive electrode 110 and it may be, for example, 20% or less, 15% or less, 10% or less, or 5% or less. Each capacity of the positive electrode 110, the negative electrode 140, and the metal layer 130 can be measured by a conventionally known method.

The average thickness of the negative electrode 140 is preferably 4 μm or more and 20 μm or less, more preferably 5 μm or more and 18 μm or less, and still more preferably 6 μm or more and 15 μm or less. In such a mode, since the occupation volume of the negative electrode 140 in the lithium secondary battery 100 decreases, the lithium secondary battery 100 has a more improved energy density.

(Positive Electrode)

The positive electrode 110 contains a positive-electrode active material, so that the lithium secondary battery 100 has excellent stability and a high output voltage. The term “positive-electrode active material” as used herein means a material for retaining a lithium ion on the positive electrode 110 and the material may also be called a host material for lithium ion. Such a positive-electrode active material is not particularly limited and examples include metal oxides and metal phosphates. The metal oxides are not particularly limited and examples include cobalt oxide-based compounds, manganese oxide-based compounds, and nickel oxide-based compounds. The metal phosphates are not particularly limited and examples include iron phosphate-based compounds and cobalt phosphate-based compounds. Examples of typical positive-electrode active materials include LiCo₂, LiNiₓCo_{y}Mn_{z}O (x+y+z=1), LiNiₓMn_{y}O (x+y=1), LiNiO₂, LiMn₂O₄, LiFePO, LiCoPO, LiFeOF, LiNiOF, and TiS₂. One or more of the positive-electrode active materials may be used either singly or in combination.

The positive electrode 110 contains, in addition to the positive-electrode active material, a lithium-containing compound (that is, the positive-electrode sacrificial agent) which causes an oxidation reaction and does not substantially cause a reduction reaction in a charge/discharge potential range of the positive-electrode active material. By the initial charge of the lithium secondary battery 100 including such a positive electrode 110, the positive-electrode active material and the positive-electrode sacrificial agent release a lithium ion and at the same time, cause an oxidation reaction and release an electron to the negative electrode 140 through an external circuit. As a result, the lithium ion derived from the positive-electrode active material and the positive-electrode sacrificial agent precipitates on the surface of the negative electrode. By the discharge (that is, initial discharge) of the resulting lithium secondary battery 100 after completion of the initial charge, electrolytically dissolving of a lithium metal precipitated on the surface of the negative electrode occurs and the electron transfers from the negative electrode 140 to the positive electrode 110 through the external circuit. Then, the positive-electrode active material receives the lithium ion and at the same time, causes a reduction reaction, while the positive-electrode sacrificial agent does not substantially cause a reduction reaction in a range of the discharge potential of the positive-electrode active material and does not substantially return to the state before the oxidation reaction. The term “initial charge” means a first charging step after the battery is assembled.

Accordingly, when the lithium secondary battery 100 is discharged after the initial charge, electrolytically dissolving of the lithium metal derived from the positive-electrode active material occurs from the negative electrode, while most of the lithium metal derived from the positive-electrode sacrificial agent remains on the negative electrode and even after completion of the discharge of the battery, some of the lithium metal remains on the negative electrode. The resulting residual lithium metal becomes a scaffold for the precipitation of a further lithium metal on the negative electrode in a charging step following the initial discharge, which facilitates uniform precipitation of the lithium metal on the negative electrode in the charging step after the initial discharge. As a result, the growth of a lithium metal into dendrite form on the negative electrode is suppressed and the resulting lithium secondary battery 100 has an excellent cycle characteristic.

The positive-electrode sacrificial agent contained in the positive electrode 110 is a lithium-containing compound which causes an oxidation reaction and does not substantially cause a reduction reaction in a charge/discharge potential range of the positive-electrode active material. The term “causes an oxidation reaction in a charge/discharge potential range of the positive-electrode active material” means that in a charge/discharge potential range of the positive-electrode active material, the agent causes an oxidation reaction to release a lithium ion and an electron (also means that the agent is decomposed by an oxidation reaction to release a lithium ion). The term “does not substantially cause a reduction reaction in a charge/discharge potential range of the positive-electrode active material” means that in a charge/discharge potential range of the positive-electrode active material, it is impossible or substantially impossible for the positive-electrode sacrificial agent to cause a reduction reaction and receive a lithium ion and an electron or to generate themselves by a reduction reaction under the ordinary reaction conditions for those skilled in the art. The term “the ordinary reaction conditions for those skilled in the art” means, for example, condition under which a lithium secondary battery is discharged. The term “substantially impossible for the positive-electrode sacrificial agent to cause a reduction reaction and receive a lithium ion and an electron or to generate themselves by a reduction reaction” means that it is impossible for 80% or more (for example, 80% or more, 85% or more, 90% or more, 95% or more, 99% or more, or 100%), each % by capacity ratio, of the positive-electrode sacrificial agent oxidized by charging of the battery to cause a reduction reaction and receive a lithium ion and an electron or to generate themselves by a reduction reaction. The ratio of the capacity of the positive-electrode sacrificial agent in the initial discharge to the capacity of it in the initial charge is 20% or less (for example, 20% or less, 15% or less, 10% or less, 5% or less, 1% or less, or 0%).

The term “charge/discharge potential range of the positive-electrode active material” as used herein means a potential range in which the oxidation reaction and the reduction reaction of the positive-electrode active material contained in the positive electrode 110 are performed. A specific value depends on the kind of the positive-electrode active material contained in the positive electrode 110, but it is typically, 2.5 V or more, 2.7 V or more, 3.0 V or more, 3.2 V or more, or 3.5 V or more and 4.5 V or less, 4.4 V or less, 4.3 V or less, or 4.2 V or less, 4.1 V or less, or 4.0 V or less, each based on an Li⁺/Li reference electrode. A representative range of the charge/discharge potential range of the positive-electrode active material is 3.0 V or more and 4.2 V or less (vs. Li⁺/Li reference electrode) and the upper and lower limits may be replaced independently by the aforementioned value. The charge/discharge potential range of the positive-electrode active material relative to the Li⁺/Li reference electrode may be determined referring to the operating voltage range of the lithium secondary battery 100. For example, when the operating voltage of the lithium secondary battery 100 is 3.0 V or more and 4.2 V or less, the charge/discharge potential range of the positive-electrode active material relative to the Li⁺/Li reference electrode can be estimated at 3.0 V or more and 4.2 V or less. In other words, the positive-electrode sacrificial agent may also be called “a lithium-containing compound which causes an oxidation reaction and does not substantially cause a reduction reaction in the operation voltage range of a lithium secondary battery”.

The positive-electrode sacrificial agent is not particularly limited and examples include lithium oxides such as Li₂O₂, lithium nitrides such as Li₃N, lithium sulfide-based solid solutions such as Li₂S—P₂S₅, Li₂S—LiCl, Li₂S—LiBr, and Li₂S—LiI, and iron-based lithium oxides such as Li₅FeO₄. One or more of the positive-electrode sacrificial agents as described above may be used either singly or in combination. As the aforesaid positive-electrode sacrificial agent, a commercially available one or that produced by a conventionally known method may be used.

The positive electrode 110 may contain a component other than the positive-electrode active material and the positive-electrode sacrificial agent. Such a component is not particularly limited and examples include known conductive additives, binders, solid polymer electrolytes, and inorganic solid electrolytes.

The conductive additive to be contained in the positive electrode 110 is not particularly limited and examples include carbon black, single wall carbon nanotube (SWCNT), multi-wall carbon nanotube (MWCNT), carbon nanofiber (CF), and acetylene black. The binder is not particularly limited and examples include polyvinylidene fluoride, polytetrafluoroethylene, styrene butadiene rubber, acrylic resins, and polyimide resins. One or more of the conductive additives and binders as described above may be used either singly or in combination. As the solid polymer electrolyte, a solid electrolyte similar to those exemplified later may be used.

The total content of the positive-electrode active material and the positive-electrode sacrificial agent in the positive electrode 110 may be, for example, 50 mass % or more and 100 mass % or less based on the total amount of the positive electrode 110. The total content of the positive-electrode active material and the positive-electrode sacrificial agent is preferably 60 mass % or more, more preferably 70 mass % or more, still more preferably 80 mass % or more, and still more preferably 90 mass % or more, based on the total amount of the positive electrode 110. The total content of the positive-electrode active material and the positive-electrode sacrificial agent is preferably 100 mass % or less, more preferably 99 mass % or less, and still more preferably 98 mass % or less, based on the total amount of the positive electrode 110.

The content of the positive-electrode sacrificial agent is preferably defined by a proportion of an irreversible capacity of the positive-electrode sacrificial agent in a cell capacity of the lithium secondary battery 100. The term “cell capacity of the lithium secondary battery” as used herein means a value obtained by calculating a total amount of the charge capacity of the positive-electrode active material and the positive-electrode sacrificial agent contained in the positive electrode 110. More specifically, the cell capacity of the lithium secondary battery 100 is obtained by finding, for each of the positive-electrode active materials and each of the positive-electrode sacrificial agents, a product of a charge capacity density (mAh/g), which is determined by charging/discharging a cell using the positive-electrode active material or positive-electrode sacrificial agent as a positive electrode and a lithium metal foil as a negative electrode at an operation voltage (for example, 3.0 V or more and 4.2 V or less) of the lithium secondary battery 100, and a mass (g) contained in the positive electrode 110 and then finding a sum of the aforesaid products of all the positive-electrode active materials and positive-electrode sacrificial agents contained in the positive electrode 110. The term “irreversible capacity of the positive-electrode sacrificial agent” is obtained by charging/discharging a cell having the positive-electrode sacrificial agent as a positive electrode and a lithium metal foil as a negative electrode at an operation voltage (for example, 3.0 V or more and 4.2 V or less) of the lithium secondary battery 100 and thereby finding an irreversible capacity density A (mAh/g) which is a difference (A1−A2) between a charge capacity density A1 and a discharge capacity density A2, calculating a product of the irreversible capacity density and the mass (g) contained in the positive electrode 110, and then finding the sum of the aforesaid products of all the positive-electrode sacrificial agents contained in the positive electrode 110.

A proportion X of the irreversible capacity of the positive-electrode sacrificial agent in the cell capacity of the lithium secondary battery 100 may be determined in accordance with the following formula (1) as a ratio of the sum of the products of an irreversible capacity density Aⱼ (mAh/g) and a content xⱼ (mass %) in the positive electrode 110 for each of the positive-electrode sacrificial agents to the sum of the products of a charge capacity density A1ₖ (mAh/g) and a content xₖ (mass %) in the positive electrode for each of the positive-electrode active materials and each of the positive-electrode sacrificial agents.

$$\begin{matrix}[ Formula 1 ] & \\ X = \frac{{\sum }_{j = Sacrificial positive electrode agent} {A}_{j} {x}_{j}}{{\sum }_{k = \begin{matrix}Positive electrode active material and \\ sacrificial positive electrode agent\end{matrix}} A {1}_{k} {x}_{k}} & ( 1 )\end{matrix}$$

When the charge capacity density (mAh/g) of each of the positive-electrode active materials and each of the positive-electrode sacrificial agents and the irreversible capacity density (mAh/g) of each of the positive-electrode sacrificial agents are known, these known values may be used. The charge capacity density, the discharge capacity density, and the content in the positive electrode 110, of each of the positive agent active materials and each of the positive-electrode sacrificial agents, can be measured using a conventionally known method and the charge capacity density and the discharge capacity density may be measured using a method described in Examples. The content in the positive electrode 110 can be measured, for example, by X-ray diffraction measurement (XRD).

The content of the positive-electrode sacrificial agent is adjusted so that the proportion of the irreversible capacity of the positive-electrode sacrificial agent in the cell capacity of the lithium secondary battery 100 is preferably 0.3% or more and 50% or less, more preferably 0.5% or more and 40% or less, still more preferably 1% or more and 35% or less, and still more preferably 1% or more and 30% or less. It is presumed that adjustment of the proportion of the irreversible capacity of the positive-electrode sacrificial agent in the cell capacity of the lithium secondary battery 100 enables the control of the proportion of a lithium metal which remains after initial charge of the lithium secondary battery 100, in the total amount of the lithium metal precipitated by the initial charge, so that when the proportion of the aforesaid irreversible capacity falls within the aforesaid range, the amount of the residual lithium metal becomes appropriate and the resulting lithium secondary battery 100 has more excellent cycle characteristic and energy density.

The content of the conductive additive in the total amount of the positive electrode 110 may be, for example, 0.5 mass % or more and 30 mass % or less, 1 mass % or more and 20 mass % or less, or 1.5 mass % or more and 10 mass % or less. The content of the binder in the total amount of the positive electrode 110 may be, for example, 0.5 mass % or more and 30 mass % or less, 1 mass % or more and 20 mass % or less, or 1.5 mass % or more and 10 mass % or less. The sum of the contents of the solid polymer electrolyte and the inorganic solid electrolyte in the total amount of the positive electrode 110 may be, for example, 0.5 mass % or more and 30 mass % or less, 1 mass % or more and 20 mass % or less, or 1.5 mass % or more and 10 mass % or less.

(Positive Electrode Current Collector)

The positive electrode 110 has, on one side thereof, a positive electrode current collector 150. The positive electrode current collector 150 is not particularly limited insofar as it is a conductor not reactive with a lithium ion in the battery. Examples of such a positive electrode current collector include aluminum.

The average thickness of the positive electrode current collector 150 is preferably 4 μm or more and 20 μm or less, more preferably 5 μm or more and 18 μm or less, and still more preferably 6 μm or more and 15 μm or less. In such a mode, an occupation volume of the positive electrode current collector 150 in the lithium secondary battery 100 decreases and the resulting lithium secondary battery 100 therefore has a more improved energy density.

(Metal Layer)

The lithium secondary battery 100 includes a metal layer 130 formed on the surface of the negative electrode 140 facing the separator 120.

In a conventional lithium secondary battery, a lithium metal which precipitates on the surface of a negative electrode is hard to grow uniformly in the plane direction and therefore, the lithium metal which precipitates on the surface of the negative electrode is likely to grow into dendrite form and the resulting battery has an inferior cycle characteristic. As a result of intensive study, the present inventors have found that even if a positive-electrode sacrificial agent as disclosed herein is added to the positive electrode of a conventional lithium secondary battery, a lithium metal which has remained after the initial discharge is hard to precipitate uniformly on the surface of the negative electrode and therefore the positive-electrode sacrificial agent fails to show its effect sufficiently and contributes little to an improvement in cycle characteristic. The present inventors have also found that the positive-electrode sacrificial agent remarkably shows an effect for improving the cycle characteristic when a metal layer 130 is formed on the surface of the negative electrode 140 than when the metal layer is not formed. The factor of it is presumed as follows, but is not limited thereto.

When the lithium secondary battery 100 has the metal layer 130 on the surface of the negative electrode 140, the surface of the negative electrode is presumed to have more improved conductivity and at the same time, have more improved flatness. This is presumed to make the electric field occurring on the surface of the negative electrode more uniform in a plane direction and make the reactivity of the precipitation reaction of a metal lithium more uniform regardless of the site on the surface of the negative electrode. As a result, in the lithium secondary battery 100 containing the positive-electrode sacrificial agent in the positive electrode 110, a lithium metal which has grown uniformly in a plane direction remains on the surface of the negative electrode after the initial discharge and the residual lithium metal showing uniform growth in the plane direction will be a scaffold for the lithium metal precipitation in a subsequent charging, which is presumed to suppress the growth of the lithium metal into dendrite form, leading to more improvement in cycle characteristic. The lithium metal may precipitate on the interface between the negative electrode 140 and the metal layer 130 or between the metal layer 130 and the separator 120.

The term “suppress the growth of the lithium metal into dendrite form” as used herein means that a lithium metal to be formed on the surface of the negative electrode by charging/discharging of the lithium secondary battery or repetition thereof is suppressed from growing into dendrite form. In other words, a lithium metal to be formed on the surface of the negative electrode by charging/discharging of the lithium secondary battery or repetition thereof is induced to grow into a non-dendrite form. The “non-dendrite form” as used herein is not particularly limited and it typically means a plate, valley, or hill form.

The metal layer 130 is not particularly limited insofar as it is a layer composed of a metal and it contains preferably at least one metal selected from the group consisting of Si, Sn, Zn, Bi, Ag, In, Pb, Sb, and Al. In such a mode, the surface of the metal layer 130 has more excellent affinity with the lithium metal and peeling-off of the precipitated lithium metal on the surface of the positive electrode can be suppressed further. In general, in a lithium secondary battery to be charged/discharged by depositing lithium metal on the surface of a negative electrode and electrolytically dissolving the deposited lithium, it is known that a reduced capacity of the lithium secondary battery is attributed peeling-off of the precipitated lithium metal. In short, peeling-off of the precipitated lithium metal is known to provide a lithium secondary battery having a deteriorated cyclic characteristic. The metal layer 130 containing the aforesaid metal can therefore suppress peeling-off of the precipitated lithium metal from the surface of the negative electrode further and the resulting lithium secondary battery has more excellent cycle characteristic.

The average thickness of the metal layer 130 is not particularly limited and is preferably 5 nm or more, more preferably 10 nm or more, and still more preferably 15 nm or more. The metal layer having a thickness in the aforesaid range tends to show its effect effectively and reliably. The average thickness of the metal layer 130 is preferably 5000 nm or less, more preferably 3000 nm or less, still more preferably 1000 nm or less, still more preferably 500 nm or less, still more preferably 300 nm or less, and particularly preferably 200 nm or less. When the metal layer has an average thickness in the aforesaid range, the resulting lithium secondary battery 100 tends to have a higher energy density and a more excellent cycle characteristic because the electrical resistance in the lithium secondary battery decreases and in addition, the occupation volume of the metal layer in the battery decreases.

The thickness of the metal layer 130 can be measured using a known measurement method. For example, it can be measured by cutting the lithium secondary battery 100 in a thickness direction and observing the metal layer 130 of the exposed cut section by SEM or TEM. The average thickness of the metal layer 130 is found by calculating an arithmetic mean of the thicknesses measured three times or more and preferably 10 times or more.

(Separator)

The separator 120 is a member for separating the positive electrode 110 from the negative electrode 140 to prevent a short circuit of the battery and in addition, for securing the ionic conductivity of a lithium ion which serves as a charge carrier between the positive electrode 110 and the negative electrode 140. It is composed of a material not having electronic conductivity and unreactive to lithium ion. The separator 120 also has a role of retaining electrolyte solution. No limitation is imposed on the separator 120 insofar as it plays the aforesaid role and examples include members composed of porous polyethylene (PE) and polypropylene (PP), and a stacked structure of them.

The separator 120 may be covered with a separator coating layer. The separator coating layer may cover both of the surfaces of the separator 120 or may cover only one of them. The separator coating layer is not particularly limited insofar as it is a member having ionic conductivity and unreactive to a lithium ion and is preferably capable of firmly adhering the separator 120 to a layer adjacent to the separator 120. Such a separator coating layer is not particularly limited and examples include members containing a binder such as polyvinylidene fluoride (PVDF), a composite material (SBR-CMC) of styrene butadiene rubber and carboxymethyl cellulose, polyacrylic acid (PAA), lithium polyacrylate (Li-PAA), polyimide (PI), polyamideimide (PAI), or aramid. The separator coating layer may be obtained by adding, to the aforesaid binder, inorganic particles such as silica, alumina, titania, zirconia, magnesium oxide, magnesium hydroxide, or lithium nitrate.

The average thickness of the separator 120 is preferably 20 μm or less, more preferably 18 μm or less, and still more preferably 15 μm or less. In such a mode, the occupation volume of the separator 120 in the lithium secondary battery 100 decreases and therefore, the resulting lithium secondary battery 100 has a more improved energy density. The average thickness of the separator 120 is preferably 5 μm or more, more preferably 7 μm or more, and still more preferably 10 μm or more. In such a mode, the positive electrode 110 can be separated from the negative electrode 140 more reliably and the short circuit of the battery can be prevented further.

(Electrolyte Solution)

The lithium secondary battery 100 may have electrolyte solution. The separator 120 may be wetted with the electrolyte solution or the lithium secondary battery 100 may be sealed with the electrolyte solution to obtain a finished product. The electrolyte solution contains an electrolyte and a solvent. It is a solution having ionic conductivity and serves as a conductive path of a lithium ion. The lithium secondary battery 100 having the electrolyte solution therefore has a more reduced internal resistance and a more improved energy density, capacity, and cycle characteristic.

The electrolyte is not particularly limited insofar as it is a salt and examples include salts of Li, Na, K, Ca, or Mg. As the electrolyte, a lithium salt is preferred. The lithium salt is not particularly limited and examples include LiI, LiCl, LiBr, LiF, LiBF₄, LiPF₆, LiAsF₆, LiSO₃CF₃, LiN(SO₂F)₂, LiN(SO₂CF₃)₂, LiN(SO₂CF₃CF₃)₂, LiB(O₂C₂H₄)₂, LiB(O₂C₂H₄)F₂, LiB(OCOCF₃)₄, LiNO₃, and Li₂SO₄. The lithium salt is preferably LiN(SO₂F)₂ from the standpoint of providing a lithium secondary battery 100 having more excellent energy density, capacity, and cycle characteristic. One or more of the aforesaid lithium salts may be used either singly or in combination.

The solvent is not particularly limited and examples include dimethyl ether, diethylene glycol dimethyl ether, triethylene glycol dimethyl ether, acetonitrile, dimethyl carbonate, diethyl carbonate, ethyl methyl carbonate, ethylene carbonate, propylene carbonate, chloroethylene carbonate, fluoroethylene carbonate, difluoroethylene carbonate, trifluoromethyl propylene carbonate, methyl acetate, ethyl acetate, propyl acetate, methyl propionate, ethyl propionate, nonafluorobutyl methyl ether, nonafluorobutyl ethyl ether, tetrafluoroethyl tetrafluoropropyl ether, trimethyl phosphate, and triethyl phosphate.

(Use of a Lithium Secondary Battery)

FIG. 2 shows one mode of the use of the lithium secondary battery of the present embodiment. The lithium secondary battery 200 has a positive electrode terminal 220 and a negative electrode terminal 210 for connecting the lithium secondary battery 200 to an external circuit and these terminals are bonded to a positive electrode current collector 150 and the negative electrode 140, respectively. The lithium secondary battery 200 is charged/discharged by connecting the negative electrode terminal 210 to one end of the external circuit and the positive electrode terminal 220 to the other end of the external circuit.

The lithium secondary battery 200 may have a solid electrolyte interfacial layer (SEI layer) at the interface between the metal layer 130 and the separator 120 by the initial charge. The lithium secondary battery may not have the SEI layer or may have it at the interface between the negative electrode 140 and the metal layer 130. The SEI layer to be formed is not particularly limited and it may contain a lithium-containing inorganic compound or a lithium-containing organic compound. The typical average thickness of the SEI layer is 1 nm or more and 10 μm or less.

The lithium secondary battery 200 is charged by applying a voltage between the positive electrode terminal 220 and the negative electrode terminal 210 to cause a current flow from the negative electrode terminal 210 to the positive electrode terminal 220 through the external circuit. When the lithium secondary battery 200 is charged, precipitation of a lithium metal occurs on the surface of the negative electrode. The precipitation of the lithium metal occurs at at least one of the interface between the negative electrode 140 and the metal layer 130 and the interface between the metal layer 130 and the separator 120.

When the positive electrode terminal 220 and the negative electrode terminal 210 are connected to the charged lithium secondary battery 200, the lithium secondary battery 200 is discharged. This discharge causes electrolytically dissolving of the precipitated lithium metal on the surface of the negative electrode.

(Method of Manufacturing a Lithium Secondary Battery)

A method of manufacturing the lithium secondary battery 100 as shown in FIG. 1 is not particularly limited insofar as it can provide a lithium secondary battery equipped with the aforesaid structure and examples of the method include the method as follows.

The positive electrode 110 is formed on the positive elective current collector 150, for example, in the following manner. The aforesaid positive-electrode active material, positive-electrode sacrificial agent, known conductive additive, and known binder are mixed to obtain a positive electrode mixture. The mixing ratio of them may be adjusted as needed so that the respective contents of the positive-electrode active material, positive-electrode sacrificial agent, conductive additive, and binder fall in the aforesaid range. By measuring the charge capacity density of the positive-electrode active material and the irreversible capacity density of the positive-electrode sacrificial agent in advance, the proportion of the irreversible capacity of the positive-electrode sacrificial agent to the cell capacity of the lithium secondary battery 100 can be controlled only by adjusting the mixing ratio by mass of the positive-electrode active material and the positive-electrode sacrificial agent. The positive electrode mixture thus obtained is applied to one of the surfaces of a metal foil (for example, Al foil) serving as a positive electrode current collector and having a predetermined thickness (for example, 5 μm or more and 1 mm or less), followed by press molding. The molded product thus obtained is punched into a predetermined size to obtain a positive electrode 110.

Next, a separator 120 having the aforesaid structure is prepared. As the separator 120, a separator produced by a conventionally known method or a commercially available one may be used.

Next, the aforesaid negative electrode material, for example, a metal foil (such as an electrolytic Cu foil) having a thickness of 1 μm or more and 1 mm or less is washed with a sulfamic-acid-containing solvent, punched into a predetermined size, ultrasonically washed with ethanol, and then dried to obtain a negative electrode 140.

Next, a metal layer 130 is formed on one side of the negative electrode 140. Examples of the method of forming a metal layer include electroless plating, electrolytic plating, vacuum deposition, sputtering, laser film deposition (PLD), and metal nanoparticle coating.

Examples of the electroless plating include a method using a plating solution containing a metal ion and a reducing agent. Specific examples include a method of immersing the negative electrode 140 in a plating solution and a method of applying a plating solution to the negative electrode 140 by spin coating. A metal layer having a desired thickness can be obtained by adjusting the immersion time in a plating solution and the concentration of the metal ion or reducing agent as needed.

Examples of the electrolytic plating include a method of performing electrolytic plating with the negative electrode 140 as a work electrode in an electrolytic plating solution containing a metal ion. A metal layer having a desired thickness can be obtained by adjusting the electrolysis conditions and the electrolysis time as needed.

Examples of the vacuum deposition include a method of depositing a metal on the negative electrode 140 to obtain a metal layer. A metal layer having a desired thickness can be obtained by adjusting the deposition time or deposition conditions as needed.

Of these methods, using the method described in Examples for the formation of a metal layer is preferred from the standpoint of improving productivity.

The positive electrode 110, the separator 120, and the negative electrode 140 having the metal layer 130 thereon, each obtained as described above, are stacked in order of mention so that the metal layer 130 faces the separator 120 and thus, a stacked body is obtained. The stacked body thus obtained is encapsulated, together with the electrolyte solution in a hermetically sealing container to obtain a lithium secondary battery 100. The hermetically sealing container is not particularly limited and examples include a laminate film.

### Second Embodiment

(Lithium Secondary Battery)

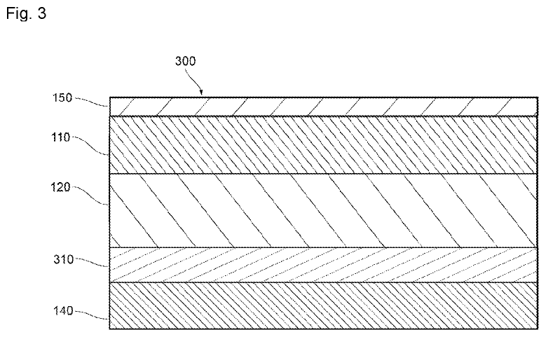

FIG. 3 is a schematic cross-sectional view of a lithium secondary battery of Second Embodiment. As shown in FIG. 3, a lithium secondary battery 300 of Second embodiment includes a positive electrode 110, a negative electrode 140 not having a negative-electrode active material, a separator 120 placed between the positive electrode 110 and the negative electrode 140, and a fibrous or porous buffering function layer 310 formed on the surface of the separator 120 facing the negative electrode 140, the buffering function layer having ionic conductivity and electronic conductivity. The positive electrode 110 has a positive electrode current collector 150 on the surface thereof opposite to the surface facing the separator 120.

The respective constitutions and preferred modes of a positive electrode current collector 150, a positive electrode 110, a separator 120, and a negative electrode 140 are similar to those of the lithium secondary battery 100 except for what will be described below and these components of the lithium secondary battery 300 exhibit effects similar to those of the lithium secondary battery 100. Similar to the lithium secondary battery 100, the lithium secondary battery 300 may contain the electrolyte solution as described above.

(Buffering Function Layer)

As shown in FIG. 3, the buffering function layer 310 is formed on the surface of the separator 120 facing the negative electrode 140 and it is a fibrous or porous layer having ionic conductivity and electronic conductivity. Since the buffering function layer 310 is present between the separator 120 and the negative electrode 140 in the present embodiment, when the lithium secondary battery 300 is charged, the surface and/or inside of the buffering function layer 310 is supplied with electrons from the negative electrode 140 and with lithium ions from the separator 120 and/or the electrolyte solution. The buffering function layer 310 is fibrous or porous, so that it has a solid portion having ionic conductivity and electronic conductivity and a pore portion composed of spaces between the solid portions. In the buffering function layer 310, therefore, the electrons and lithium ions supplied as described above react on the surface of the aforesaid solid portion, which is inside the buffering function layer, and a lithium metal precipitates in the pore portion. The term “solid portion” in the buffering function layer as used herein embraces a semisolid such as gel.

In a conventional lithium secondary battery, the precipitation site of a lithium metal is limited to the surface of a negative electrode and therefore, the growth direction of the lithium metal is limited to from the surface of the negative electrode to a separator and the lithium metal tends to grow into dendrite form. In a lithium secondary battery having a buffering function layer such as the lithium secondary battery 300 of the present embodiment, on the other hand, the lithium metal precipitates not only on the surface of the negative electrode but also on the surface of the solid portion of the buffering function layer, leading to an increase in the surface area of the reaction site of a lithium metal precipitation reaction. As a result, it is presumed that in the lithium secondary battery 300, the reaction rate of the lithium metal precipitation reaction is controlled mildly and anisotropic growth of a lithium metal, that is, formation of a lithium metal which has grown into dendrite form is suppressed. As a result of intensive research, the present inventors have found that a lithium secondary battery which has a positive electrode containing the positive-electrode sacrificial agent and has the buffering function layer introduced in the battery remarkably exhibits the effect of the positive-electrode sacrificial agent. This is presumed to occur because during initial charging, a lithium metal precipitates uniformly in a plane direction on the surface of the solid portion of the buffering function layer and the surface of the negative electrode by the aforesaid mechanism and even after initial discharging, the lithium metal which has grown uniformly in a plane direction remains, so that the residual lithium metal which has uniformly grown in the plane direction serves a scaffold for lithium metal precipitation in the subsequent charging and growth of the lithium metal into dendrite form is suppressed. The factor is however not limited to the aforesaid one.

In the present embodiment, the term “a lithium metal precipitates on the negative electrode” means that a lithium metal precipitates on at least one of the surface of the negative electrode, the surface of the solid portion of the buffering function layer, and the surface of an SEI layer formed on the surface of the negative electrode and/or the solid portion of buffering function layer. In the lithium secondary battery 300, therefore, the lithium metal may precipitate on the surface of the negative electrode 140 (the interface between the negative electrode 140 and the buffering function layer 310) or on the inside of the buffering function layer 310 (surface of the solid portion of the buffering function layer).

In the lithium secondary battery 300 of the present embodiment, a lithium metal precipitates not only on the surface of the negative electrode but also on the surface of the solid portion of the buffering function layer 310 so as to fill the pore portion of the buffering function layer. In the lithium secondary battery 300, the buffering function layer 310 therefore functions also as a buffering layer for suppressing the volume expansion of the battery caused by charging/discharging. In other words, charging of a conventional lithium secondary battery not having a buffering function layer causes precipitation of a lithium metal on the surface of the negative electrode and the battery after charging has an expanded cell volume compared with the battery before charging. On the other hand, in the lithium secondary battery 300 of the present embodiment, expansion of the cell volume by charging can be suppressed because a lithium metal precipitates not only on the surface of the negative electrode but also in the pore portion of the buffering function layer 310. The lithium secondary battery of the present embodiment is therefore particularly useful as a battery whose permissible volume expansion ratio is low such as a battery for compact electronic device or the like.

The buffering function layer 310 is not particularly limited insofar as it is fibrous or porous and has ionic conductivity and electronic conductivity. Non-limiting examples of the buffering function layer include those obtained by covering all or some of a fibrous or porous ionically conductive layer with an electronically conductive layer, those obtained by covering all or some of a fibrous or porous electronically conductive layer with an ionically conductive layer, and those obtained by entwining a fibrous ionically conductive layer and a fibrous electronically conductive layer.

The ionically conductive layer is not limited insofar as it is a layer capable of conducting ions and examples include solid electrolytes and pseudo-solid electrolytes (which will hereinafter be called “gel electrolytes”) containing an inorganic or organic salt.

The solid electrolyte and gel electrolyte are not particularly limited insofar as they are used generally in a lithium secondary battery and known materials can be selected for them as needed. The resin included in the solid electrolyte or gel electrolyte is not particularly limited and examples include resins having an ethylene oxide unit in the main chain and/or side chain, such as polyethylene oxide (PEO), acrylic resins, vinyl resins, ester resins, nylon resins, polyvinylidene fluoride (PVDF), polyacrylonitrile (PAN), polysiloxane, polyphosphazene, poly(methyl methacrylate), polyimide, aramid, polylactic acid, polyethylene, polystyrene, polyurethane, polypropylene, polybutylene, polyacetal, polysulfone, and polytetrafluoroethylene. One or more of the aforesaid resins may be used either singly or in combination.

Examples of the salt contained in the solid electrolyte or gel electrolyte include salts of Li, Na, K, Ca, or Mg. The lithium salt is not particularly limited and examples include LiI, LiCl, LiBr, LiF, LiBF₄, LiPF₆, LiAsF₆, LiSO₃CF₃, LiN(SO₂F)₂, LiN(SO₂CF₃)₂, LiN(SO₂CF₃CF₃)₂, LiB(O₂C₂H₄)₂, LiB(C₂O₄)₂, LiB(O₂C₂H₄)F₂, LiB(OCOCF₃)₄, LiNO₃, and Li₂SO₄. One or more of the aforesaid salts or lithium salts may be used either singly or in combination.

The content ratio of the lithium salt to the resin in the solid electrolyte or gel electrolyte may be determined by a ratio ([Li]/[O]) of lithium atoms which the lithium salt has to oxygen atoms which the resin has. The content ratio of the lithium salt to the resin in the solid electrolyte or gel electrolyte may be adjusted so that the ratio ([Li]/[O]) be 0.02 or more and 0.20 or less, 0.03 or more and 0.15 or less, or 0.04 or more and 0.12 or less.

The solid electrolyte or gel electrolyte may contain, in addition to the resin and the salt, the electrolyte solution which the lithium secondary battery 300 may contain.

The electronically conductive layer is not limited insofar as it is capable of conducting electrons and examples include a metal film. Non-limiting examples of the metal which may be contained in the electronically conductive layer include SUS, Si, Sn, Sb, Al, Ni, Cu, Sn, Bi, Ag, Au, Pt, Pb, Zn, In, Bi—Sn, and In—Sn. As the metal to be contained in the electronically conductive layer is preferably Si, Sn, Zn, Bi, Ag, In, Pb, Sb, or Al from the standpoint of enhancing affinity with the lithium metal.

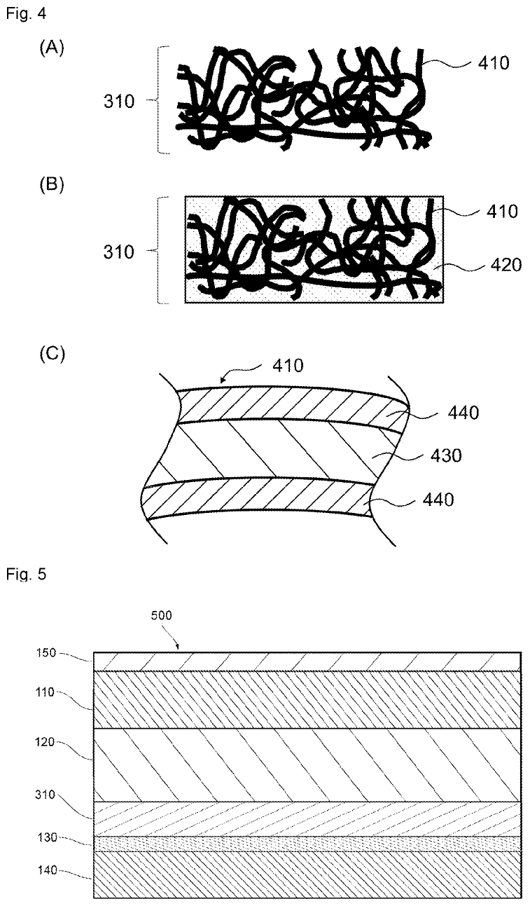

One embodiment of the buffering function layer 310 is a fibrous buffering function layer. FIG. 4(A) is a schematic cross-sectional view of a fibrous buffering function layer. The buffering function layer 310 shown in FIG. 4(A) is composed of an ionically and electronically conductive fiber 410 which is a fiber having ionic conductivity and electronic conductivity. In other words, the term “the buffering function layer is fibrous” in the present embodiment means that the buffering function layer contains a fiber or is composed of a fiber so that it has solid portions and pore portions composed of the space between the solid portions.

When the lithium secondary battery having the buffering function layer 310 as shown in FIG. 4(A) is charged, a lithium metal precipitates on the surface of the solid portion of the buffering function layer, that is, on the surface of the ionically and electronically conductive fiber 410. In such a mode, therefore, as shown by its schematic cross-sectional view in FIG. 4(B), a lithium metal 420 precipitates on the surface of the ionically and electronically conductive fiber 410, which is a solid portion of the buffering function layer, to fill the pore portion of the buffering function layer with the lithium metal.

FIG. 4(C) is a schematic cross-sectional view showing one embodiment of the ionically and electronically conductive fiber 410. As shown in FIG. 4(C), in this embodiment, the ionically and electronically conductive fiber 410 has a fibrous ionically conductive layer 430 and an electronically conductive layer 440 which covers the surface of the ionically conductive layer 430 therewith. The ionically conductive layer 430 may have, for example, the constitution as described above as the ionically conductive layer, and the electronically conductive layer 440 may have, for example, the constitution as described above as the electronically conductive layer.

The fibrous ionically conductive layer 430 has an average fiber diameter of preferably 30 nm or more and 5000 nm or less, more preferably 50 nm or more and 2000 nm or less, still more preferably 70 nm or more and 1000 nm or less, and still more preferably 80 nm or more and 500 nm or less. When the average fiber diameter of the ionically conductive layer falls within the aforesaid range, the surface area of a reaction site on which a lithium metal precipitates is in a more appropriate range and the resulting lithium secondary battery therefore tends to have a more improved cycle characteristic.

The average thickness of the electronically conductive layer 440 is preferably 1 nm or more and 300 nm or less, more preferably 5 nm or more and 200 nm or less, and still more preferably 10 nm or more and 150 nm or less. The electronically conductive layer having an average thickness within the aforesaid range can more appropriately keep the electronic conductivity of the ionically and electronically conductive fiber 410 and therefore, the resulting lithium secondary battery tends to have a more improved cycle characteristic.

In another embodiment, the buffering function layer 310 of the lithium secondary battery 300 shown in FIG. 3 may be porous. The porous buffering function layer may have, for example, a porous ionically conductive layer, particularly, an ionically conductive layer having a continuous pore and an electronically conductive layer which covers the surface of the ionically conductive layer.

The buffering function layer is fibrous or porous and accordingly, it has pores. The porosity of the buffering function layer is not particularly limited and it is preferably 50% or more, more preferably 60% or more, and still more preferably 70% or more in terms of vol %. When the buffering function layer has a porosity in the aforesaid range, the surface area of a reaction site where the lithium metal can precipitate shows a further increase, so that the resulting lithium secondary battery has a more improved cycle characteristic. Such a mode tends to exhibit an effect of suppressing the cell volume expansion more effectively and reliably. The porosity of the buffering function layer is not particularly limited and it may be 99% or less, 95% or less, or 90% or less in terms of vol. %

The average thickness of the buffering function layer is preferably 100 μm or less, more preferably 50 μm or less, and still more preferably 30 μm or less. When the buffering function layer has an average thickness in the aforesaid range, an occupation volume of the buffering function layer 310 in the lithium secondary battery 300 decreases and the resulting battery has a more improved energy density. In addition, the average thickness of the buffering function layer is preferably 1 μm or more, more preferably 4 μm or more, and still more preferably 7 μm or more. When the buffering function layer has an average thickness in the aforesaid range, the surface area of a reaction site in which a lithium metal can precipitate shows a further increase so that the resulting battery tends to have a more improved cycle characteristic. Such a mode tends to exhibit an effect of suppressing the cell volume expansion more effectively and reliably.

The fiber diameter of the fibrous ionically conductive layer, the thickness of the electronically conductive layer, the porosity of the buffering function layer, and the thickness of the buffering function layer can be measured by known measurement methods. For example, the thickness of the buffering function layer can be determined by etching the surface of the buffering function layer by focused ion beam (FIB) to expose the section thereof and observing the thickness of the buffering function layer at the exposed section by SEM or TEM.

The fiber diameter of the fibrous ionically conductive layer, the thickness of the electronically conductive layer, and the porosity of the buffering function layer can be determined by observing the surface of the buffering function layer by a transmission electron microscope. The porosity of the buffering function layer may be calculated by subjecting the observed image of the surface of the buffering function layer to binary analysis with an image analysis software and finding a proportion of the buffering function layer in the total area of the image.

The aforesaid measurement values are each calculated by finding the average of the values measured three times or more, preferably 10 times or more.

When the buffering function layer contains a metal reactive with lithium, the total capacity of the negative electrode 140 and the buffering function layer 310 is sufficiently small relative to the capacity of the positive electrode 110 and for example, it may be 20% or less, 15% or less, 10% or less, or 5% or less. The capacity of each of the positive electrode 110, the negative electrode 140, and the buffering function layer 310 can be measured by a conventionally known method.

In FIG. 3, the negative electrode 140 may have an SEI layer on the surface thereof and In FIG. 4, the ionically and electronically conductive fiber 410 may have an SEI layer on the surface thereof.

(Method of Manufacturing a Secondary Battery)

The lithium secondary battery 300 as shown in FIG. 3 may be manufactured in a manner similar to the aforesaid method of manufacturing the lithium secondary battery 100 of First Embodiment shown in FIG. 1 except that a buffering function layer 310 is formed instead of the metal layer 130.

The method of producing the buffering function layer 310 is not particularly limited insofar it can provide a fibrous or porous layer having ionic conductivity and electronic conductivity and for example, the method may be performed as follows.

A fibrous buffering function layer, which is one as shown in FIG. 4(C), having an ionically and electronically conductive fiber 410 which has a fibrous ionically conductive layer 430 and an electronically conductive layer 440 covering the surface of the ionically conductive layer 430 can be produced as follows.

First, a solution obtained by dissolving the aforesaid resin (for example, PVDF) in an appropriate organic solvent (for example, N-methylpyrrolidone) is applied with a doctor blade onto the surface of a separator 120 prepared in advance. The separator 120 having the resin solution applied thereto is immersed in a water bath and then dried sufficiently at room temperature to form a fibrous ionically conductive layer on the separator 120 (the ionically conductive layer may be allowed to exhibit its ion conductive function, for example, by pouring an electrolyte solution at the time of assembly of a battery). Then, an appropriate metal (for example, Ni) is deposited under vacuum conditions on the separator having the fibrous ionically conductive layer formed thereon to obtain a fibrous buffering function layer.

The porous buffering function layer having a porous ionically conductive layer and an electronically conductive layer which covers the surface of the ionically conductive layer can also be produced as follows.

First, by using a solution obtained by dissolving the aforesaid resin (for example, PVDF) in an appropriate solvent (for example, N-methylpyrrolidone), a porous ionically conductive layer having a continuous pore is formed on the surface of the separator 120 by a conventionally known method (for example, a method using phase separation from solvent, a method using a foaming agent, or the like) (the ionically conductive layer may be allowed to exhibit its ion conductive function, for example, by pouring an electrolyte solution at the time of the assembly of a battery). Then, by depositing an appropriate metal (for example, Ni), under vacuum conditions, on the separator having the porous ionically conductive layer formed thereon, a porous buffering function layer can be obtained.

The assembly of the lithium secondary battery may be performed referring to the method of manufacturing the lithium secondary battery 100 of First embodiment. Described specifically, a stacked body can be obtained by stacking the positive electrode 110, the separator 120 having the buffering function layer 310 formed thereon, and the negative electrode 140 in order of mention so that the buffering function layer 310 faces the negative electrode 140. The stacked body thus obtained and an electrolyte solution are encapsulated in a hermetically sealing container to obtain the lithium secondary battery 300.

### Third Embodiment

(Lithium Secondary Battery)

FIG. 5 is a schematic cross-sectional view of a lithium secondary battery of Third Embodiment. As shown in FIG. 5, a lithium secondary battery 500 of Third Embodiment includes the positive electrode 110, the negative electrode 140 not having a negative-electrode active material, the separator 120 placed between the positive electrode 110 and the negative electrode 140, the metal layer 130 formed on the surface of the negative electrode 140 facing the separator 120, and the fibrous or porous buffering function layer 310 formed on the surface of the separator 120 facing the negative electrode 140, the buffering function layer having ionic conductivity and electronic conductivity. The positive electrode 110 has a positive electrode current collector 150 on the surface thereof opposite to the surface facing the separator 120.

The respective constitutions and preferred modes of the positive electrode current collector 150, the positive electrode 110, the separator 120, the metal layer 130, the buffering function layer 310, and the negative electrode 140 are similar to those of the lithium secondary battery 100 of First Embodiment and the lithium secondary battery 300 of Second Embodiment. These components of the lithium secondary battery 500 exhibit effects similar to those of the lithium secondary battery 100 and the lithium secondary battery 300. The lithium secondary battery 500 may, similar to the lithium secondary battery 100, contain the electrolyte solution as described above.

Compared with the lithium secondary battery 100 and the lithium secondary battery 300, each including either one of the metal layer 130 and the buffering function layer 310, the lithium secondary battery 500 including both of the metal layer 130 and the buffering function layer 310 has a more improved cycle characteristic because the growth of a lithium metal into dendrite form is suppressed further.

### Fourth Embodiment

(Lithium Secondary Battery)

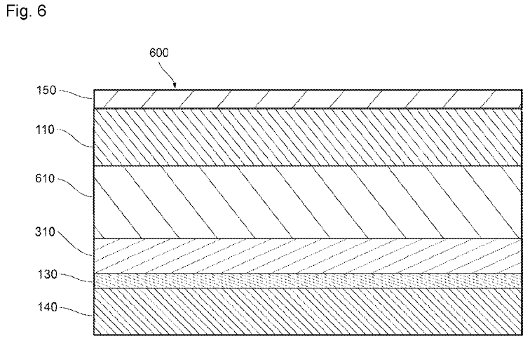

FIG. 6 is a schematic cross-sectional view of a lithium secondary battery of Fourth Embodiment. As shown in FIG. 6, a lithium secondary battery 600 of Fourth Embodiment includes the positive electrode 110, the negative electrode 140 not having a negative-electrode active material, a solid electrolyte 610 placed between the positive electrode 110 and the negative electrode 140, the metal layer 130 formed on the surface of the negative electrode 140 facing the solid electrolyte 610, and the fibrous or porous buffering function layer 310 formed on the surface of the solid electrolyte 610 facing the negative electrode 140, the buffering function layer having ionic conductivity and electronic conductivity. The positive electrode 110 has the positive electrode current collector 150 on the surface thereof opposite to the surface facing the solid electrolyte 610.

The respective constitutions and preferred modes of the positive electrode current collector 150, the positive electrode 110, the metal layer 130, the buffering function layer 310, and the negative electrode 140 are similar to those of the lithium secondary battery 100 of First Embodiment, the lithium secondary battery 300 of Second Embodiment, and the lithium secondary battery 500 of Third Embodiment. These components of the lithium secondary battery 600 exhibit effects similar to those of the lithium secondary battery 100, the lithium secondary battery 300, and the lithium secondary battery 500.

(Solid Electrolyte)

In general, a battery having liquid electrolyte tends to be exposed to different physical pressures, which are applied from the electrolyte to the surface of a negative electrode, at different locations due to the shaking of the liquid. On the other hand, since the lithium secondary battery 600 has the solid electrolyte 610, a pressure applied from the solid electrolyte 610 to the surface of the negative electrode 140 becomes more uniform and the shape of a lithium metal precipitated on the surface of the negative electrode 140 can be made more uniform. This means that in such a mode, a carrier metal which precipitates on the surface of the negative electrode 140 is suppressed further from growing into dendrite form and the resulting lithium secondary battery 600 therefore has a more excellent cycle characteristic.

The solid electrolyte 610 is not particularly limited insofar as it is used generally for a lithium solid secondary battery and a known material can be selected as needed, depending on the use of the lithium secondary battery 600. The solid electrolyte 610 preferably has ionic conductivity and no electronic conductivity. Since the solid electrolyte 610 has ionic conductivity and no electronic conductivity, the resulting lithium secondary battery 600 has more reduced internal resistance and in addition, the lithium secondary battery 600 is prevented from causing a short circuit inside thereof. As a result, the lithium secondary battery 600 therefore has a more excellent energy density, capacity, and cycle characteristic.

The solid electrolyte 610 is not particularly limited and examples include those containing a resin and a lithium salt. The resin is not particularly limited and examples include those given as the examples of the resin which can be contained in the ionically conductive layer of the buffering function layer 310. The lithium salt is not particularly limited and examples include those given as the examples of the lithium salt which can be contained in the ionically conductive layer of the buffering function layer 310. One or more of these resins and lithium salts may be used either singly or in combination.

In the solid electrolyte 610, a content ratio of the lithium salt to the resin, that is, the ratio ([Li]/[O]) is preferably 0.02 or more and 0.20 or less, more preferably 0.03 or more and 0.15 or less, and still more preferably 0.04 or more and 0.12 or less.

The solid electrolyte 610 may contain a component other than the aforesaid resin and lithium salt. Such a component is not particularly limited and examples include solvents and salts other than lithium salts. The salts other than lithium salts are not particularly limited and examples include salts of Na, K, Ca, and Mg.

The solvent is not particularly limited and examples include those given as the solvent of the electrolyte solution which can be contained in the aforesaid lithium secondary battery 100.

The average thickness of the solid electrolyte 610 is preferably 20 μm or less, more preferably 18 μm or less, and still more preferably 15 μm or less. In such a mode, an occupation volume of the solid electrolyte 610 in the lithium secondary battery 600 decreases so that the resulting lithium secondary battery 600 has a more improved energy density. The average thickness of the solid electrolyte 610 is preferably 5 μm or more, more preferably 7 μm or more, and still more preferably 10 μm or more. In such a mode, the positive electrode 110 can be separated from the negative electrode 140 more reliably and a short circuit of the resulting battery can be suppressed further.

The solid electrolyte 610 embraces a gel electrolyte. The gel electrolyte is not particularly limited and examples include those containing a polymer, an organic solvent, and a lithium salt. The polymer in the gel electrolyte is not particularly limited and examples include copolymers of polyethylene and/or polyethylene oxide, polyvinylidene fluoride, and copolymers of polyvinylidene fluoride and hexafluoropropyrene.

(Method of Manufacturing a Secondary Battery)

The lithium secondary battery 600 can be manufactured in a manner similar to that of the lithium secondary battery 500 of Third Embodiment except for the use of the solid electrolyte instead of the separator.

The method of manufacturing a solid electrolyte 610 is not particularly limited insofar as it is a method capable of providing the aforesaid solid electrolyte 610 and it may be performed, for example, as follows. A resin and a lithium salt conventionally used for a solid electrolyte (for example, the aforesaid resin as a resin which can be contained in the solid electrolyte 610, and a lithium salt) are dissolved in an organic solvent (for example, N-methylpyrrolidone or acetonitrile). The solution thus obtained is cast on a molding substrate to have a predetermined thickness and thus, the solid electrolyte 610 is obtained. The mixing ratio of the resin and the lithium salt may be determined based on a ratio ([Li]/[O]) of lithium atoms of the lithium salt to oxygen atoms of the resin. The ratio ([Li]/[O]) is, for example, 0.02 or more and 0.20 or less. The molding substrate is not particularly limited and, for example, a PET film or a glass substrate may be used.

### Modification Example

The aforesaid embodiments are examples for describing the present invention. They do not intend to limit the present invention only thereto and the present invention may have various modifications without departing from the gist thereof.

For example, from the lithium secondary battery 600 of Fourth Embodiment, either one of the metal layer 130 or the buffering function layer 310 may be omitted.

For example, in the lithium secondary battery 100 of First Embodiment, the metal layer 130 may be formed on both sides of the negative electrode 140. In this case, the lithium secondary battery has a structure in which the following components are stacked in order of mention: positive electrode/separator/metal layer/negative electrode/metal layer/separator/positive electrode. The lithium secondary battery in such a mode has more improved capacity. The lithium secondary battery 300 of Second Embodiment, the lithium secondary battery 500 of Third Embodiment, and the lithium secondary battery 600 of Fourth Embodiment may have a similar stacked structure.

The lithium secondary battery of the present embodiment may be a lithium solid secondary battery. A battery in such a mode does not need electrolyte solution so that it is free from a problem of electrolyte solution leakage and has more improved safety.

The lithium secondary battery of the present embodiment may or may not have a lithium foil between the separator or solid electrolyte and the negative electrode before initial charging. The lithium secondary battery of the present embodiment not having a lithium foil between the separator or solid electrolyte and the negative electrode before initial charging has more excellent safety and productivity because use of a lithium metal having high flammability is not required in the manufacture of the battery.

The lithium secondary battery of the present embodiment may or may not have a current collector which is to be placed on the surface of the negative electrode and/or positive electrode so as to be contact with the negative electrode or positive electrode. Such a current collector is not particularly limited and examples include those usable as a negative electrode material. When the lithium secondary battery has neither a positive electrode current collector nor a negative electrode current collector, the positive electrode and the negative electrode themselves serve as current collectors, respectively.

The lithium secondary battery of the present embodiment may have, at the positive electrode and/or negative electrode, a terminal for connecting it to an external circuit. For example, a metal terminal (for example, Al, Ni, or the like) having a length of 10 μm or more and 1 mm or less may be bonded to one or both of the positive electrode current collector and the negative electrode. For bonding, a conventionally known method may be used and for example, ultrasonic welding is usable.

The term “an energy density is high” or “has a high energy density” as used herein means that the capacity of a battery per total volume or total mass is high. It is preferably 800 Wh/L or more or 350 Wh/kg or more, more preferably 900 Wh/L or more or 400 Wh/kg or more, and still more preferably 1000 Wh/L or more or 450 Wh/kg or more.

The term “having an excellent cycle characteristic” as used herein means that a decreasing ratio of the capacity of a battery is small before and after the expected number of charging/discharging cycles in ordinary use. Described specifically, it means that when a first discharge capacity after the initial charging/discharging and a capacity after the number of charging/discharging cycles expected in ordinary use are compared, the capacity after charging/discharging cycles has hardly decreased compared with the first discharge capacity after the initial charging/discharging. The “number expected in ordinary use” varies depending on the usage of the lithium secondary battery and it is, for example, 30 times, 50 times, 70 times, 100 times, 300 times, or 500 times. The term “capacity after charging/discharging cycles hardly decreased compared with the first discharge capacity after the initial charging/discharging” means, though differing depending on the usage of the lithium secondary battery, that the capacity after charging/discharging cycles is, for example, 60% or more, 65% or more, 70% or more, 75% or more, 80% or more, or 85% or more, each in the first discharge capacity after the initial charging/discharging.

### EXAMPLES

The present invention will hereinafter be described in detail by Examples and Comparative Examples. The present invention is not limited by the following Examples.

[Manufacture of Lithium Secondary Battery]

The respective steps for the manufacture of a lithium secondary battery were performed as follows.

(Formation of Negative Electrode)

A negative electrode was obtained by washing a 10-μm electrolytic Cu foil with a solvent containing sulfamic acid, punching the resulting foil into a predetermined size, ultrasonically washing it with ethanol, and then drying it.

(Formation of Separator)

As a separator, that obtained by coating 2-μm polyvinylidene fluoride (PVDF) on both sides of a 12-μm polyethylene microporous membrane and having a predetermined size was formed.

(Formation of Positive Electrode)

A mixture of a positive-electrode active material and a positive-electrode sacrificial agent (96 parts by mass), 2 parts by mass of carbon black as a conductive additive, and 2 parts by mass of polyvinylidene fluoride (PVDF) as a binder was applied onto one side of a 12-μm Al foil serving as a positive electrode current collector, followed by pressing molding. The molded product thus obtained was punched into a predetermined size by punching to obtain a positive electrode.

As a positive-electrode active material, LiNi_{0.85}Co_{0.12}Al_{0.03}O₂ was used and as a positive-electrode sacrificial agent, those listed in Table 1 were used. The irreversible capacity of each of the positive-electrode sacrificial agents is shown in Table 1.

Of the positive-electrode sacrificial agents listed in Table 1, Li₂O₃ and Li₃N were commercially available ones. The positive-electrode sacrificial agent containing Li₂S was prepared by the method described in Japanese Patent Laid-Open No. 2019-145299. Described specifically, Li₂S and P₂S₅, LiCl, LiBr, or LiI were mixed in a mortar to give a molar ratio of 80:20 and a solid-phase reaction was caused using a planetary ball mill device in an argon atmosphere to obtain a lithium sulfide-based solid solution. Then, the resulting lithium sulfide-based solid solution and activated carbon were mixed in a ball mill at a mass ratio of 90:10 to obtain a positive-electrode sacrificial agent. The Li₅FeO₄ was prepared by the method described in Chem. Mater. 2010, 22, 1263-1270 1263. Described specifically, LiOH·H₂O and Fe₂O₃ were ground and mixed, and the resulting mixture was calcined for 72 hours under the condition of 800° C. in a nitrogen atmosphere to obtain a positive-electrode sacrificial agent.

The mixing ratio of the positive-electrode active material and the positive-electrode sacrificial agent was adjusted so that the proportion of the irreversible capacity of the positive-electrode sacrificial agent in the cell capacity of the battery be a value described in Table 1 as “addition rate (proportion % in the cell capacity)” by using a charge capacity density (mAh/g) of the positive-electrode active material and the positive-electrode sacrificial agent and an irreversible capacity density A (mAh/g) of the positive-electrode sacrificial agent, each measured as described below. The total amount of the positive-electrode active material and the positive-electrode sacrificial agent was adjusted so that the cell capacity of the lithium secondary battery was 60 mAh. The content of the positive-electrode sacrificial agent in the total amount of the positive electrode is described in Table 1 as “addition amount (mass %)”.

The positive-electrode active material or positive-electrode sacrificial agent, PVDF, the conductive additive, and N-methylpyrrolidone (NMP) were mixed into a slurry and the resulting slurry was applied onto an aluminum foil, dried, and then pressed. A test cell using a lithium metal as a counter electrode was formed. By charging to a voltage of 4.2 V with an electric current of 0.2 mAh/cm² and then discharging to give a voltage of 3.0 V, the charge capacity density (mAh/g) and/or irreversible capacity density A (mAh/g) were determined.

(Formation of Metal Layer)

After the negative electrode obtained was degreased and washed with pure water, it was immersed in an Sn-ion-containing plating bath. The surface of the negative electrode was electroplated while horizontally leaving it at rest to plate the surface with tin. The negative electrode was taken out from the plating bath, washed with ethanol, and then washed with pure water. In such a manner, a metal layer was formed on one of the surfaces of the negative electrode. Electrolysis time was adjusted so that the metal layer had a thickness of 100 nm.

(Formation of Buffering Function Layer)

A resin solution obtained by dissolving a PVDF resin in N-methylpyrrolidone (NMP) was applied onto a separator with a doctor blade. The separator onto which the resin solution was applied was immersed in a water bath and then dried sufficiently at room temperature to form a fibrous and ionically conductive layer on the separator (it is to be noted that the ionically conductive layer becomes ionically conductive when an electrolyte solution (a 4M dimethoxyethane (DME) solution of LiN(SO₂F)₂(LFSI)) which will be described later is poured at the time of battery assembly).

The average fiber diameter of the fibrous and ionically conductive layer formed on the separator was observed and measured with a scanning electron microscope (SEM) to be 100 nm.

Then, Ni was deposited under vacuum conditions on the separator having a fibrous and ionically conductive layer formed thereon. The ionically conductive layer deposited with Ni was observed with an SEM equipped with an energy dispersion type X-ray analyzer (EDX). It was confirmed that the Ni was distributed so as to cover the fibrous and ionically conductive layer and that a fibrous buffering function layer covered at the surface of the fibrous and ionically conductive layer with the electronically conductive layer was obtained.

The section of the buffering function layer prepared using FIB was observed by SEM and the average thickness of the buffering function layer was found to be 10 μm. As a result of the observation of the buffering function layer with a transmission electron microscope, the average thickness of the thin Ni film, that is, the electronically conductive layer and the porosity of the buffering function layer were found to be 20 nm and 90%, respectively.

(Assembly of Battery)

As electrolyte solution, 4M dimethoxyethane (DME) solution of LiN(SO₂F)₂(LFSI) was prepared.

Then, a stacked body was obtained by stacking a positive electrode, a separator, and a negative electrode in order of mention. Stacking was performed by placing a buffering function layer to face the negative electrode when the separator had the buffering function layer thereon and by placing a metal layer to face the separator when the negative electrode had the metal layer thereon. Further, a 100-μm Al terminal and 100-μm Ni terminal were bonded to the positive electrode and the negative electrode, respectively by ultrasonic welding and then the bonded body was inserted into a laminate-film outer container. Then, the electrolyte solution was poured in the outer container. The resulting outer container was hermetically sealed to obtain a lithium second battery.

### Examples 1 to 10

By using the positive-electrode sacrificial agents listed in Table 1, lithium secondary batteries having a positive electrode, a separator having a buffering function layer formed thereon, and a negative electrode having a metal layer formed thereon were manufactured. The mixing ratio of a positive-electrode active material and the positive-electrode sacrificial agent was adjusted so that a proportion of the irreversible capacity of the positive-electrode sacrificial agent in the cell capacity of the battery be a value described in Table 1 as “addition rate (percent % in the cell capacity)”. More specifically, the content of the positive-electrode sacrificial agent in the total amount of the positive electrode was adjusted to a value described in Table 1 as “addition amount (mass %)”.

### Example 11

A lithium secondary battery was obtained in a manner similar to that of Example 2 except for the use of a separator not having a buffering function layer formed thereon instead of the separator having the buffering function layer formed thereon.

### Example 12

A lithium secondary battery was obtained in a manner similar to that of Example 2 except for the use of a negative electrode not having a metal layer formed thereon instead of the negative electrode having the metal layer formed thereon.

### Comparative Example 1

A lithium secondary battery was obtained in a manner similar to that of Example 2 except that a separator not having a buffering function layer formed thereon was used instead of the separator having the buffering function layer formed thereon, a negative electrode not having a metal layer thereon was used instead of the negative electrode having the metal layer formed thereon, and the sacrificial agent was not used.

### Comparative Example 2

A lithium secondary battery was obtained in a manner similar to that of Example 2 except that a separator not having a buffering function layer thereon was used instead of the separator having the buffering function layer formed thereon and a negative electrode not having at metal layer thereon was used instead of the negative electrode having the metal layer formed thereon.

[Evaluation of Energy Density and Cycle Characteristic]

The energy density and cycle characteristic of each of the lithium secondary batteries manufactured in Examples and Comparative Examples were evaluated as follows.

After each of the lithium secondary batteries thus manufactured was charged (initial charge) at 0.2 mAh/cm² to a voltage of 4.2 V, it was discharged (initial discharge) at 0.2 mAh/cm² to a voltage of 3.0 V. Then, a charge/discharge cycle consisting of charging at 1.0 mAh/cm² to a voltage of 4.2 V and discharging at 1.0 mAh/cm² to a voltage of 3.0 V was repeated 99 times at a temperature condition of 25° C. In any of Examples and Comparative Examples, the capacity (initial capacity) determined from the initial charge was 60 mAh. Supposing that the initial charge/discharge cycle is counted as a first cycle, a proportion of a discharge capacity determined from the 100th cycle discharge of the charge/discharge cycle to a discharge capacity determined from the 2nd cycle discharge of the charge/discharge cycle was calculated as a capacity maintaining ratio (%) and was used as an index of the cycle characteristic. This means that the higher the capacity maintaining ratio, the more excellent the cycle characteristic. The capacity maintaining ratio in each example is shown in Table 1.

TABLE 1

| | | | Positive-electrode sacrificial agent | | | | |
|---|---|---|---|---|---|---|---|
| | | Buffering | | Irreversible | Addition | Addition rate | Capacity |
| Sample | Metal | function | | capacity | amount | (percent % in | maintaining |
| No. | layer | layer | Compound | (mAh/g) | (mass %) | cell capacity) | rate (%) |
| Ex. 1 | ∘ | ∘ | Li₅FeO₄ | 600 | 0.33 | 1 | 82 |
| Ex. 2 | ∘ | ∘ | Li₅FeO₄ | 600 | 3.3 | 10 | 85 |
| Ex. 3 | ∘ | ∘ | Li₅FeO₄ | 600 | 10.0 | 30 | 82 |
| Ex. 4 | ∘ | ∘ | Li₅FeO₄ | 600 | 13.3 | 40 | 60 |
| Ex. 5 | ∘ | ∘ | Li₂S—P₂S₅ | 800 | 2.5 | 10 | 81 |
| Ex. 6 | ∘ | ∘ | Li₂S—LiCl | 850 | 2.4 | 10 | 80 |
| Ex. 7 | ∘ | ∘ | Li₂S—LiBr | 830 | 2.4 | 10 | 79 |
| Ex. 8 | ∘ | ∘ | Li₂S—LiI | 870 | 2.3 | 10 | 82 |
| Ex. 9 | ∘ | ∘ | Li₂O₂ | 1100 | 1.8 | 10 | 83 |
| Ex. 10 | ∘ | ∘ | Li₃N | 1200 | 1.7 | 10 | 79 |
| Ex. 11 | ∘ | — | Li₅FeO₄ | 600 | 3.3 | 10 | 80 |
| Ex. 12 | — | ∘ | Li₅FeO₄ | 600 | 3.3 | 10 | 80 |
| Comp. | — | — | — | — | — | — | 20 |
| Ex. 1 | | | | | | | |
| Comp. | — | — | Li₅FeO₄ | 600 | 3.3 | 10 | 30 |
| Ex. 2 | | | | | | | |

In Table 1, “—” means that the battery does not have a positive-electrode sacrificial agent, a metal layer, and/or a buffering function layer and “∘” means that the battery has a metal layer and/or a buffering function layer.

It is apparent from Table 1 that the batteries of Examples 1 to 12 having at least one of the metal layer and the buffering function layer and containing the positive-electrode sacrificial agent have a higher capacity maintaining ratio and a more excellent cycle characteristic compared with those of Comparative Examples 1 and 2 which are different from those of the aforesaid Examples.

The lithium secondary battery of the present invention has a high energy density and an excellent cycle characteristic so that it has industrial applicability as a power storage device to be used for various uses.
100, 200, 300, 500, 600 . . . lithium secondary battery
110 . . . positive electrode
120 . . . separator
130 . . . metal layer
140 . . . negative electrode
150 . . . positive electrode current collector
210 . . . negative electrode terminal
220 . . . positive electrode terminal
310 . . . buffering function layer
410 . . . ionically and electronically conductive fiber
420 . . . lithium metal
430 . . . ionically conductive layer
440 . . . electronically conductive layer
610 . . . solid electrolyte

What is claimed is:

1. A lithium secondary battery, comprising:
a positive electrode,
a negative electrode not having a negative-electrode active material,
a separator placed between the positive electrode and the negative electrode,
at least one selected from the group consisting of a metal layer formed on a surface of the negative electrode facing the separator, and a fibrous or porous buffering function layer formed on a surface of the separator facing the negative electrode, the buffering function layer having ionic conductivity and electronic conductivity, and
electrolyte solution,
wherein the positive electrode comprises a positive-electrode active material and a lithium-containing compound causing an oxidation reaction and not substantially causing a reduction reaction in a charge/discharge potential range of the positive-electrode active material.

2. A lithium secondary battery, comprising:
a positive electrode,
a negative electrode not having a negative-electrode active material,
a solid electrolyte placed between the positive electrode and the negative electrode and containing electrolyte solution, and
at least one selected from the group consisting of a metal layer formed on a surface of the negative electrode facing the solid electrolyte, and a fibrous or porous buffering function layer formed on a surface of the solid electrolyte facing the negative electrode, the buffering function layer having ionic conductivity and electronic conductivity,
wherein the positive electrode comprises a positive-electrode active material and a lithium-containing compound causing an oxidation reaction and not substantially causing a reduction reaction in a charge/discharge potential range of the positive-electrode active material.

3. The lithium secondary battery according to claim 1, comprising both the metal layer and the buffering function layer.

4. The lithium secondary battery according to claim 1, wherein a proportion of an irreversible capacity of the lithium-containing compound in a cell capacity of the lithium secondary battery is 1% or more and 30% or less.

5. The lithium secondary battery according to claim 1, wherein the buffering function layer has a porosity of 50% or more.

6. The lithium secondary battery according to claim 1, wherein the buffering function layer has a fibrous or porous ionically conductive layer and an electronically conductive layer which covers the ionically conductive layer therewith.

7. The lithium secondary battery according to claim 1, wherein the metal layer has an average thickness of 5 nm or more and 5000 nm or less.

8. The lithium secondary battery according to claim 1, wherein the metal layer contains at least one metal selected from the group consisting of Si, Sn, Zn, Bi, Ag, In, Pb, Sb, and Al.

9. The lithium secondary battery according to claim 1, wherein the lithium secondary battery is a lithium secondary battery in which charging and discharging are performed by depositing lithium metal on the surface of the negative electrode and electrolytically dissolving the deposited lithium.

10. The lithium secondary battery according to claim 1, wherein the negative electrode is an electrode consisting of at least one selected from the group consisting of Cu, Ni, Ti, Fe, and other metals that do not react with Li, alloys thereof, and stainless steel (SUS).

11. The lithium secondary battery according to claim 1, wherein the negative electrode does not have a lithium foil on the surface thereof before initial charge.

12. The lithium secondary battery according to claim 1, wherein the battery has an energy density of 350 Wh/kg or more.

13. The lithium secondary battery according to claim 2, comprising both the metal layer and the buffering function layer.

14. The lithium secondary battery according to claim 2, wherein a proportion of an irreversible capacity of the lithium-containing compound in a cell capacity of the lithium secondary battery is 1% or more and 30% or less.

15. The lithium secondary battery according to claim 2, wherein the buffering function layer has a porosity of 50% or more.

16. The lithium secondary battery according to claim 2, wherein the buffering function layer has a fibrous or porous ionically conductive layer and an electronically conductive layer which covers the ionically conductive layer therewith.

17. The lithium secondary battery according to claim 2, wherein the metal layer has an average thickness of 5 nm or more and 5000 nm or less.

18. The lithium secondary battery according to claim 2, wherein the metal layer contains at least one metal selected from the group consisting of Si, Sn, Zn, Bi, Ag, In, Pb, Sb, and Al.

19. The lithium secondary battery according to claim 2, wherein the lithium secondary battery is a lithium secondary battery in which charging and discharging are performed by depositing lithium metal on the surface of the negative electrode and electrolytically dissolving the deposited lithium.
